(19) United States
(12) Patent Application Publication
(10) Pub. No.: US 2018/0311757 A1
(43) Pub. Date: Nov. 1, 2018

(54) ADDITIVE MANUFACTURING CONTROL SYSTEMS

(71) Applicant: DIVERGENT TECHNOLOGIES, INC., Los Angeles, CA (US)

(72) Inventors: John Russell BUCKNELL, El Segundo, CA (US); Eahab Nagi EL NAGA, Topanga, CA (US); Kevin Robert CZINGER, Santa Monica, CA (US); Broc William TenHOUTEN, Rancho Palos Verdes, CA (US)

(21) Appl. No.: 15/582,457

(22) Filed: Apr. 28, 2017

(51) Int. Cl. B23K 15/00; B33Y 30/00; B33Y 10/00; B23K 26/342

(52) U.S. Cl. CPC B23K 15/0086; B23K 26/342; B33Y 10/00; B33Y 30/00

(57) ABSTRACT

Systems and methods for control in additive manufacturing systems are provided. A powder-bed fusion apparatus can include an energy beam source that generates an energy beam and a deflector that applies the energy beam to fuse powder material to create a 3-D object based on an object model. The system can also include a characterizer that obtains information relating to fusing the powder material. The characterizer can be a sensor that measures the shape of the object, a processor that determines a physics-based model of the object, etc. The system can also include a comparator that determines a variation from the object model based on the information, and a compensator that modifies the application of energy to the powder material based on the variation. For example, applied energy can be increased in areas that require higher energy to completely fuse powder material, such areas of thicker powder layer.

### BACKGROUND

### Field

The present disclosure relates generally to Additive Manufacturing systems, and more particularly, to control systems in Additive Manufacturing.

### Background

Additive Manufacturing (“AM”) systems, also described as 3-D printer systems, can produce structures (referred to as build pieces) with geometrically complex shapes, including some shapes that are difficult or impossible to create with conventional manufacturing processes. AM systems, such as powder-bed fusion (PBF) systems, create build pieces layer-by-layer. Each layer or ‘slice’ is formed by depositing a layer of powder and exposing portions of the powder to an energy beam. The energy beam is applied to melt areas of the powder layer that coincide with the cross-section of the build piece in the layer. The melted powder cools and fuses to form a slice of the build piece. The process can be repeated to form the next slice of the build piece, and so on. Each layer is deposited on top of the previous layer. The resulting structure is a build piece assembled slice-by-slice from the ground up.

Build pieces are expected to conform to desired print parameters, such as a desired shape, a desired material density, desired mechanical characteristics, etc. However, build pieces often do not exactly conform to the desired print parameters. In some cases, the lack of conformity can require post-processing techniques, such as sanding, filing, etc., to correct the shape of the build piece, which can increase production costs. In some cases, the build piece cannot be fixed and must be discarded, which can lower yield and significantly increase production costs.

### SUMMARY

Several aspects of apparatuses and methods for control systems in AM will be described more fully hereinafter.

In various aspects, an apparatus for powder-bed fusion can include a powder-bed fusion system including an energy beam source that generates an energy beam and a deflector that applies the energy beam to fuse powder material to create a three-dimensional (3-D) object based on an object model, a characterizer that obtains information relating to the fusing of the powder material, a comparator that determines a variation from the object model based on the information, and a compensator that modifies the application of energy to the powder material based on the variation.

In various aspects, an apparatus for powder-bed fusion can include an adaptive controller that provides instructions for printing a 3-D object, the instructions based on a data model of the 3-D object, a powder-bed fusion system that prints the 3-D object based on the instructions, a feedback system configured to sense a shape of at least a portion of the printed 3-D object, compare the sensed shape with a reference shape to determine a variation parameter, and update the instructions based on the variation parameter.

In various aspects, a method of powder-bed fusion can include generating an energy beam, applying the energy beam to fuse powder material to create a 3-D object based on an object model, obtaining information relating to the fusing of the powder material, determining a variation from the object model based on the information, and modifying the application of energy to the powder material based on the information.

In various aspects, a method of powder-bed fusion can include providing instructions for printing a 3-D object, the instructions based on a data model of the 3-D object, printing the 3-D object based on the instructions, sensing a shape of at least a portion of the printed 3-D object, comparing the sensed shape with a reference shape to determine a variation parameter, and updating the instructions based on the variation parameter.

Other aspects will become readily apparent to those skilled in the art from the following detailed description, wherein is shown and described only several embodiments by way of illustration. As will be realized by those skilled in the art, concepts herein are capable of other and different embodiments, and several details are capable of modification in various other respects, all without departing from the present disclosure. Accordingly, the drawings and detailed description are to be regarded as illustrative in nature and not as restrictive.

### BRIEF DESCRIPTION OF THE DRAWINGS

Various aspects of will now be presented in the detailed description by way of example, and not by way of limitation, in the accompanying drawings, wherein:

FIGS. 1A-D illustrate an example PBF system during different stages of operation.

FIG. 2 illustrates a side view of an exemplary sagging deformation in a PBF system that can result in overhang areas.

FIG. 3 illustrates an exemplary PBF apparatus including closed-loop control.

FIG. 4 illustrates an exemplary PBF apparatus including feed forward control.

FIG. 5 illustrates an exemplary operation of a comparator.

FIGS. 6A-C illustrate an exemplary application of energy to a powder layer using modified printing instructions.

FIG. 7 is a flowchart illustrating an exemplary method of closed-loop compensation for PBF systems.

FIGS. 8A-C illustrate another exemplary application of energy to a powder layer using modified printing instructions.

FIG. 9 is a flowchart illustrating an exemplary method of feed forward compensation for PBF systems.

FIGS. 10A-E illustrate an exemplary PBF apparatus with post-processing closed-loop control.

FIG. 11 is a flowchart illustrating another exemplary method of compensation for PBF systems.

### DETAILED DESCRIPTION

The detailed description set forth below in connection with the appended drawings is intended to provide a description of various exemplary embodiments of the concepts disclosed herein and is not intended to represent the only embodiments in which the disclosure may be practiced. The term “exemplary” used in this disclosure means “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the concepts to those skilled in the art. However, the disclosure may be practiced without these specific details. In some instances, well-known structures and components may be shown in block diagram form, or omitted entirely, in order to avoid obscuring the various concepts presented throughout this disclosure.

This disclosure is directed to control systems in AM, such as powder-bed fusion (PBF). Current PBF systems can achieve a component geometrical accuracy between ±20 μm and ±130 μm, with a surface roughness of Rₐ=25 μm. The smallest wall thickness achievable by PBF is 150 μm. On the other hand, electron beam melting (EBM) systems can achieve an Rₐ=40 μm and a smallest wall thickness of 700 μm. This presents a challenge when smooth surfaces or sub-millimeter features are required. Moreover, the internal features of some 3-D printed parts may not be uniform due to phenomena such as discontinuous melt vectors, “balling” effect, uneven powder distribution, and incomplete melting. These phenomena can limit dimensional accuracy, speed, and throughput.

One reason for non-uniformity is that areas of powder materials exposed to the energy beam can experience shrinkage in volume as the materials melt, consolidate, and solidify into a solid mass. In this regard, the height of the melted areas can be lower than the rest of the powder bed, causing a thicker layer of powder material to be deposited on top of these areas during the deposition of the next powder layer. In various embodiments, the extra thickness of powder can be determined and the application of energy to the powder material can be increased to compensate for the increase in energy needed to melt the extra thickness of powder. This approach can, for example, ensure that each layer is fully melted and reduce the porosity in the 3-D build pieces.

In various embodiments, the build piece can be built based on an object model, which can specify the desired shape of the build piece. The object model may include other desired characteristics of the build piece as well, such as density, internal stresses, completeness of fusing, etc. Before, during, and/or after a printing process, a variation from an object model can be determined. For example, the shrinkage of the actual build piece can be determined by comparing the actual build piece to the object model of the build piece. The shrinkage can result in an extra thickness of powder deposited in the next powder layer. The extra thickness of powder layer over areas of shrinkage can be determined based on the determined shrinkage, for example. In some embodiments, the shrinkage can be determined in real time, by sensing the shape of the actual build piece (for example, by optical measurements). In some embodiments, the shrinkage can be determined prior to the printing process based on, for example, a physics-based model that can predict the shape of the actual build piece by accounting for thermal factors, gravitational factors, etc.

In various embodiments, 3-D printer accuracy and throughput improvements may be achieved through compensation for variations in environmental temperature, humidity, material chemistry and granularity variations, laser strength, layer thickness, and nearby part geometry.

In various embodiments, a 3-D printer can print a standardized test part/pattern, which can then be scanned for comparison with the object model. Deviations and variances from the geometry data can be measured and calculated. Compensations can then be made for the variations in printer performance before starting to print a production build piece.

In various embodiments, an optical scan of the build piece can be performed before and after the printing of each layer. A monitoring system can be set up to scan the powder bed after the powder coating process and to determine the distribution of powder material. If there are areas where powders do not cover, the coating mechanism can be activated again to coat the layer. Improvements can be applied by utilizing the monitoring system after each layer is scanned. If there are areas that are missed in the scanning of the energy beam or that experienced only partial melting of powder materials, the energy beam can be activated to re-scan these areas.

In various embodiments, a high-resolution thermal imaging system can be used to create a closed feedback loop for self-calibrated accuracy. The high-resolution thermal imaging device can monitor the formation of melt vectors during the energy beam exposure for discontinuity or dislocation. The feedback loop can compensate for drift and width of the melt vectors such that the geometrical accuracy and print quality is maintained. Calibration coupons may be permanently affixed within the build chamber to guarantee the accuracy of the imaging systems.

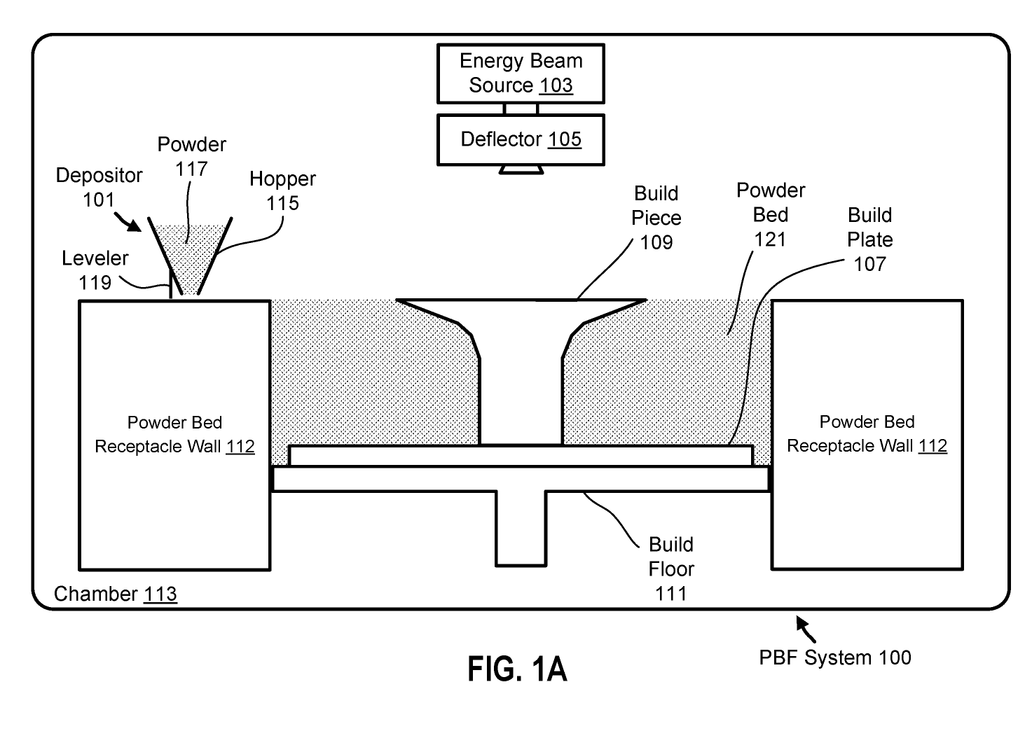

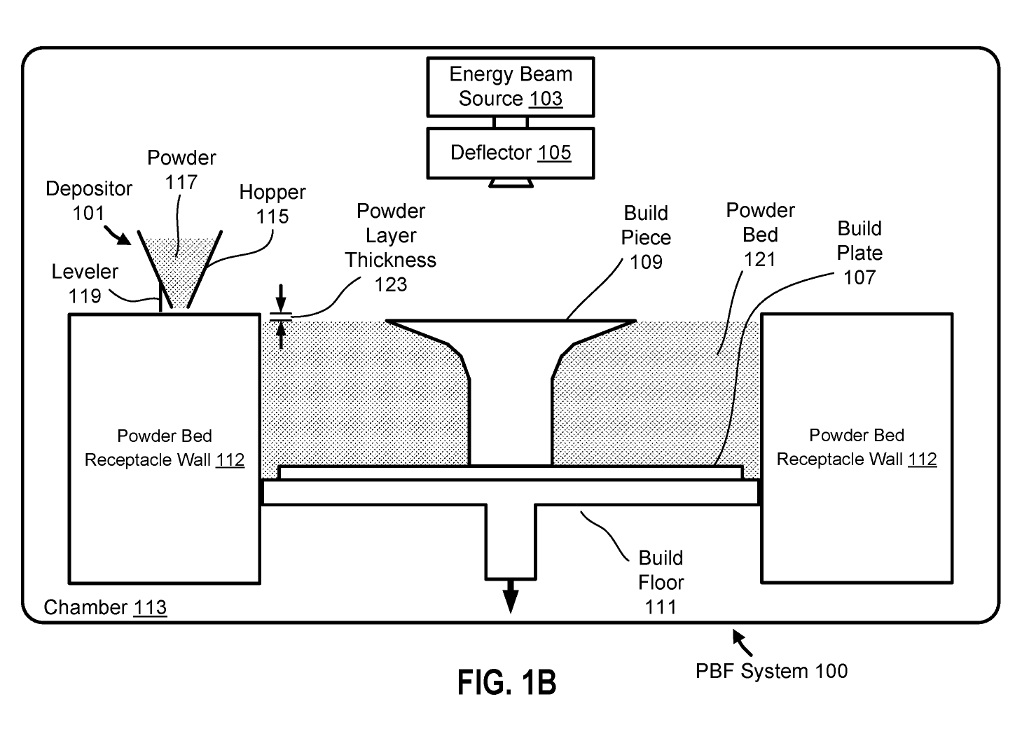

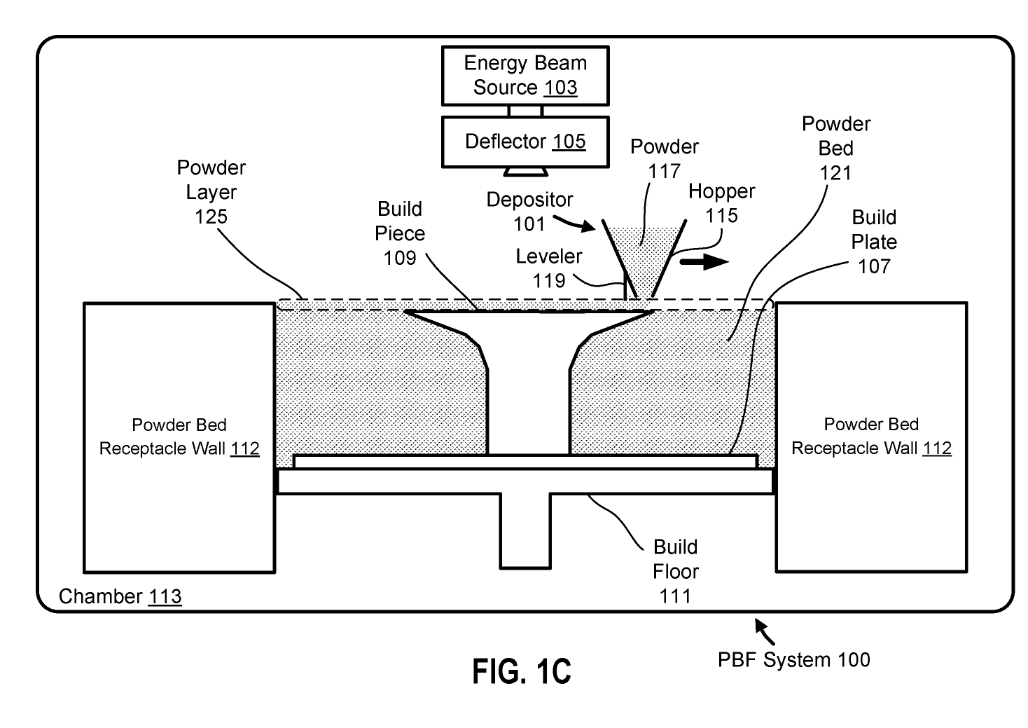

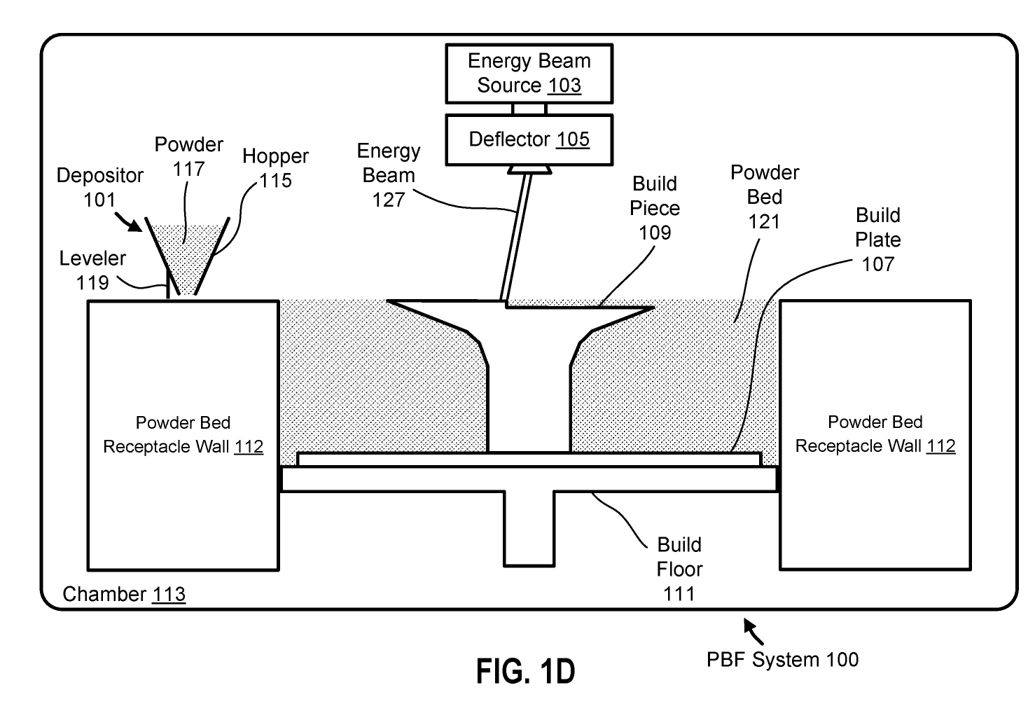

FIGS. 1A-D illustrate respective side views of an exemplary PBF system 100 during different stages of operation. As noted above, the particular embodiment illustrated in FIGS. 1A-D is one of many suitable examples of a PBF system employing principles of this disclosure. It should also be noted that elements of FIGS. 1A-D and the other figures in this disclosure are not necessarily drawn to scale, but may be drawn larger or smaller for the purpose of better illustration of concepts described herein. PBF system 100 can include a depositor 101 that can deposit each layer of metal powder, an energy beam source 103 that can generate an energy beam, a deflector 105 that can apply the energy beam to fuse the powder material, and a build plate 107 that can support one or more build pieces, such as a build piece 109. PBF system 100 can also include a build floor 111 positioned within a powder bed receptacle. The walls of the powder bed receptacle 112 generally define the boundaries of the powder bed receptacle, which is sandwiched between the walls 112 from the side and abuts a portion of the build floor 111 below. Build floor 111 can progressively lower build plate 107 so that depositor 101 can deposit a next layer. The entire mechanism may reside in a chamber 113 that can enclose the other components, thereby protecting the equipment, enabling atmospheric and temperature regulation and mitigating contamination risks. Depositor 101 can include a hopper 115 that contains a powder 117, such as a metal powder, and a leveler 119 that can level the top of each layer of deposited powder.

Referring specifically to FIG. 1A, this figure shows PBF system 100 after a slice of build piece 109 has been fused, but before the next layer of powder has been deposited. In fact, FIG. 1A illustrates a time at which PBF system 100 has already deposited and fused slices in multiple layers, e.g., 150 layers, to form the current state of build piece 109, e.g., formed of 150 slices. The multiple layers already deposited have created a powder bed 121, which includes powder that was deposited but not fused.

FIG. 1B shows PBF system 100 at a stage in which build floor 111 can lower by a powder layer thickness 123. The lowering of build floor 111 causes build piece 109 and powder bed 121 to drop by powder layer thickness 123, so that the top of the build piece and powder bed are lower than the top of powder bed receptacle wall 112 by an amount equal to the powder layer thickness. In this way, for example, a space with a consistent thickness equal to powder layer thickness 123 can be created over the tops of build piece 109 and powder bed 121.

FIG. 1C shows PBF system 100 at a stage in which depositor 101 is positioned to deposit powder 117 in a space created over the top surfaces of build piece 109 and powder bed 121 and bounded by powder bed receptacle walls 112. In this example, depositor 101 progressively moves over the defined space while releasing powder 117 from hopper 115. Leveler 119 can level the released powder to form a powder layer 125 that has a thickness substantially equal to the powder layer thickness 123 (see FIG. 1B). Thus, the powder in a PBF system can be supported by a powder material support structure, which can include, for example, a build plate 107, a build floor 111, a build piece 109, walls 112, and the like. It should be noted that the illustrated thickness of powder layer 125 (i.e., powder layer thickness 123 (FIG. 1B)) is greater than an actual thickness used for the example involving 150 previously-deposited layers discussed above with reference to FIG. 1A.

FIG. 1D shows PBF system 100 at a stage in which, following the deposition of powder layer 125 (FIG. 1C), energy beam source 103 generates an energy beam 127 and deflector 105 applies the energy beam to fuse the next slice in build piece 109. In various exemplary embodiments, energy beam source 103 can be an electron beam source, in which case energy beam 127 constitutes an electron beam. Deflector 105 can include deflection plates that can generate an electric field or a magnetic field that selectively deflects the electron beam to cause the electron beam to scan across areas designated to be fused. In various embodiments, energy beam source 103 can be a laser, in which case energy beam 127 is a laser beam. Deflector 105 can include an optical system that uses reflection and/or refraction to manipulate the laser beam to scan selected areas to be fused.

In various embodiments, the deflector 105 can include one or more gimbals and actuators that can rotate and/or translate the energy beam source to position the energy beam. In various embodiments, energy beam source 103 and/or deflector 105 can modulate the energy beam, e.g., turn the energy beam on and off as the deflector scans so that the energy beam is applied only in the appropriate areas of the powder layer. For example, in various embodiments, the energy beam can be modulated by a digital signal processor (DSP).

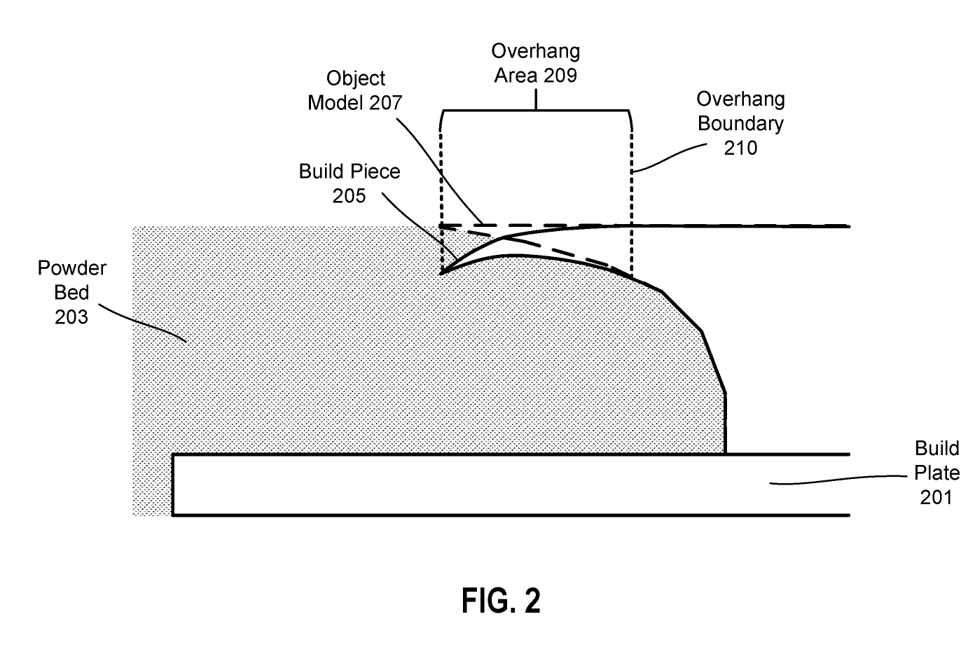

FIG. 2 illustrates a side view of an exemplary sagging deformation in a PBF system that can result in overhang areas. FIG. 2 shows a build plate 201 and a powder bed 203. In powder bed 203 is a build piece 205. An object model 207 is illustrated by a dashed line for the purpose of comparison. In one embodiment, object model 207 includes data from the data model created in CAD for use as an input to the AM processor to render the build piece. Object model 207 shows the desired shape of the build piece. Build piece 205 overlaps object model 207 in most places, i.e., in places that have no deformation. Thus, in areas to the right of overhang boundary 210, the solid line characterizing the build piece 205 overlaps with the dashed line defined in the object model 207. However, a sagging deformation occurs in an overhang area 209. In this example, overhang area 209 is formed from multiple slices fused on top of one another. In this case, the deformation worsens as overhang area 209 extends from the bulk of build piece 205.

It should be noted that some problems, such as deformations, higher residual stresses, etc., can occur in areas in which powder in one layer is fused near the edge of the slice in the layer below, even though the fusing does not occur directly over loose powder. For example, unexpectedly high temperatures can result when fusing powder near the edge of a slice below because there is less fused material below to conduct heat away. These problems can be particularly severe where the slices below form a sharp edge.

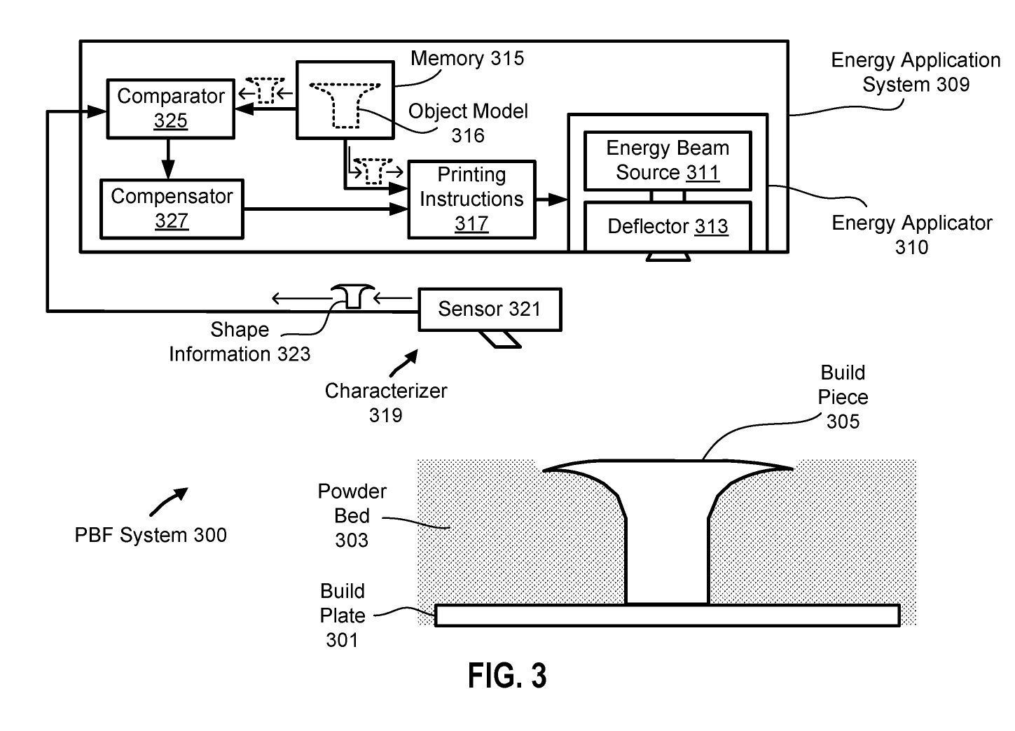

FIG. 3 illustrates an exemplary PBF apparatus 300 including closed-loop control. FIG. 3 shows a build plate 301, a powder bed 303, and a build piece 305. An energy application system 309 can apply energy to fuse powder material in deposited powder layers. For the purpose of illustration, the powder depositor is not shown in this figure. Energy application system 309 can include an energy applicator 310, which can include an energy beam source 311 and a deflector 313. Energy application system can also include a processor 314 and a computer memory 315, such as a random access memory (RAM), computer storage disk (e.g., hard disk drive, solid state drive), etc. Memory 315 can store an object model 316 and printing instructions 317. Printing instructions 317 can include instructions for each powder layer in the printing process, and the instructions can control how energy beam source 311 and deflector 313 scan each powder layer. For example, printing instructions 317 can control printing parameters such as scan rate, beam power, location of beam fusing, etc. Printing instructions 317 can be determined by processor 314 based on object model 316. In other words, processor 314 can generate printing instructions 317 by determining the scan rate, beam power, location of beam fusing, etc., to form each slice of build piece 305 based on object model 316. Energy applicator 310 can receive printing instructions 317 from memory 315 and can apply an energy beam to fuse powder material to create a build piece 305 based on the printing instructions.

PBF apparatus 300 can include a characterizer 319 that obtains information relating to the fusing of the powder material. In this example, characterizer 319 can be a sensor 321 that can sense information about the shape of build piece 305. For example, sensor 321 can include an optical sensor, such as a camera. Sensor 321 can sense shape information 323, e.g., dimensional measurements, of build piece 305 and can send the shape information to a comparator 325. For example, after each slice of build piece 305 is fused by energy application system 309, sensor 321 can sense the shape of the build piece before the next layer of powder material is deposited and send the sensed shape as shape information 323 to comparator 325.

Comparator 325 can obtain object model 316 from memory 315 and can perform a comparison of the object model and shape information 323 to determine a variation from the object model. For example, some portions of build piece 305 are sagging compared to object model 316. Comparator 325 can send information of the variation to a compensator 327. Compensator 327 can modify print instructions 317 based on the variation. For example, based on the variation, compensator 327 can determine areas of the next powder layer that will be thicker than the rest of the layer. Compensator 327 can modify print instructions 317 to increase the application of energy in the thicker powder areas in the next scan, in order to ensure the powder material in the thicker areas is fused properly. For example, compensator 327 can modify print instructions 317 to increase the beam power in the thicker areas and/or to decrease the scan rate in the thicker areas to apply more energy to these areas.

In various embodiments, the characterizer 319 can include an edge sensor that senses information of an edge of fused powder material. For example, problems with fusing often can occur at or near the edge of a slice. In these cases, an edge sensor may provide beneficial information about the shape of the edge of a slice. In various embodiments, the edge sensor can sense information such as the shape, the location, the height, etc., of an edge of fused powder material.

In various embodiments, the characterizer can include a thermal sensor, e.g., thermocouples, infrared sensor, etc., that senses thermal information. In various embodiments, the characterizer can include an optical sensor, such as a camera.

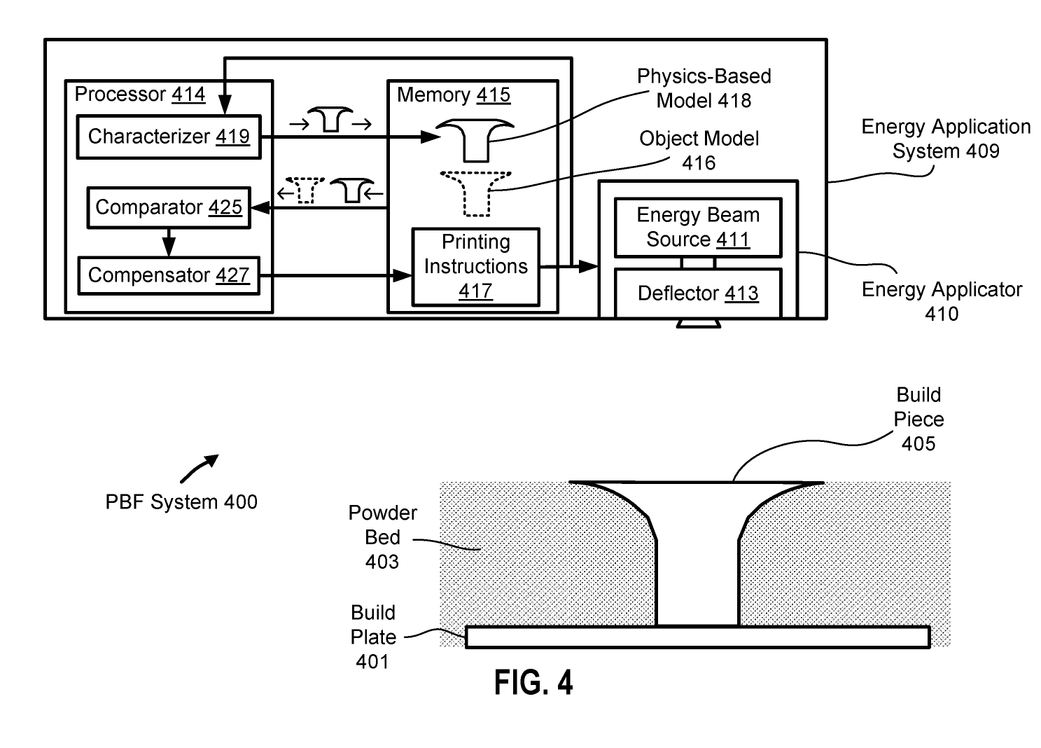

FIG. 4 illustrates an exemplary PBF apparatus 400 including feed forward control. FIG. 4 shows a build plate 401, a powder bed 403, and a build piece 405. An energy application system 409 can apply energy to fuse powder material in deposited powder layers. For the purpose of illustration, the powder depositor is not shown in this figure. Energy application system 409 can include an energy applicator 410, which can include an energy beam source 411 and a deflector 413. Energy application system can also include a processor 414 and a computer memory 415, such as a RAM, computer storage disk, etc. Memory 415 can store an object model 416 and printing instructions 417. Printing instructions 417 can include instructions for each powder layer in the printing process, and the instructions can control how energy beam source 411 and deflector 413 scan each powder layer. For example, printing instructions 417 can control printing parameters such as scan rate, beam power, location of beam fusing, etc.

In this example, printing instructions 417 can be determined by processor 414 based on object model 416 and a physics-based model 418. In particular, processor 414 can include a characterizer 419 that can obtain information relating to the fusing of the powder material. More specifically, characterizer 419 can receive printing instructions 417 from memory 415 and can determine a physics-based model 418 of build piece 405 by applying physical modeling to the printing instructions. For example, characterizer 419 can execute software stored in memory 415 that can predict the shape of the build piece based on printing instructions 417 using physical modelling. The predicted shape of the build piece is physics-based model 418, which is stored in memory 415. In this example, FIG. 4 illustrates that the shape of physics-based model 418 includes sagging at edge areas of the build piece. The sagging may have been determined by modeling the behavior of the heated powder material based on fluid dynamics modeling, determining the effectiveness of beam heating based on thermodynamics modeling, determining a force due to the depositing of the powder material based on physical mechanics modeling, etc.

Thus, according to physics-based model 418, if the build piece were printed using printing instructions 417 currently stored in memory 415, the build piece would have sagging portions. However, printing instructions 417 can be modified prior to the printing process to eliminate or reduce sagging. In particular, a comparator 425 of processor 414 can receive object model 416 and physics-based model 418 from memory 415 and can perform a comparison of the object model and physics-based model to determine a variation from the object model. In this way, comparator 425 can determine that some portions of physics-based model 418 are sagging compared to object model 416. Comparator 425 can send information of the variation to a compensator 427 of processor 414. Compensator 427 can modify print instructions 417 based on the variation. For example, based on the variation, compensator 427 can determine that less energy should be applied in areas that would sag according to physics-based model 418. Compensator 427 can modify print instructions 417 to decrease the application of energy in these areas in order to prevent or reduce sagging. For example, compensator 427 can modify print instructions 417 to apply less energy to areas that would sag by decreasing the beam power in these areas and/or to increasing the scan rate in these areas. In this way, for example, printing instructions 417 can be modified prior to the printing operation, based on a physics-based model.

In various embodiments, multiple iterations of the above process can be performed. For example, the modified printing instructions 417 can be fed back into characterizer 419, the characterizer can determine an updated physics-based model, comparator 425 can compare the updated physics-based model to object model 416 and send updated variations to compensator 427, and the compensator can update the modified printing instructions. The iteration can continue until the variation becomes smaller than a threshold tolerance, for example. At this point, modified printing instructions 417 can be used for printing.

Energy applicator 410 can receive modified printing instructions 417 from memory 415 and can apply an energy beam to fuse powder material to create a build piece 405 based on the modified printing instructions. In this example of feed forward control, build piece 405 has the correct shape because the printing instructions were modified prior to printing.

Thus, in various embodiments that utilize a physics-based model, a set of printing instructions can be created prior to the printing process. The characterizer can determine the physics-based model based on the original set of printing instructions before the printing process begins. The comparator can compare the physics-based model to the object model to determine variations between the models. The compensator can modify the printing instructions to compensate for the variations, such that the actual build piece will be printed according to the object model. Furthermore, in various embodiments the process of modifying the printing instructions can be an iterative process in which a first modified set of printing instructions can be generated, the physics-based model can be updated based on the first modified set of printing instructions, the updated physics-based model can be compared to the object model, if any variations are greater than a threshold tolerance, a second set of modified printing instructions can be determined, and the process can be repeated until no variations are greater than the threshold tolerance.

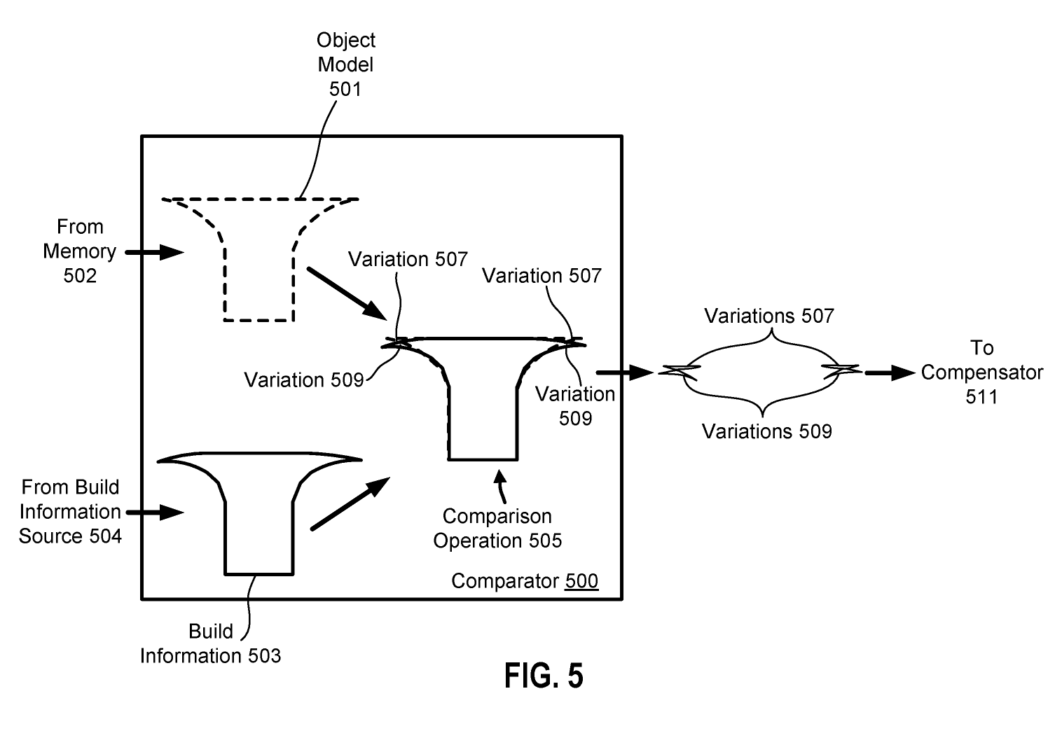

FIG. 5 illustrates an exemplary operation of a comparator 500. Comparator 500 can receive an object model 501 from a memory 502. Comparator 500 can also receive build information 503 from a build information source 504, such as a memory, a sensor, etc. Build information 503 can be, for example, information of the build piece obtained by a sensor, such as shape information 323 from sensor 321 of FIG. 3. Build information 503 can be, for example, information of a physics-based model, such as physics-based model 418 of FIG. 4. Comparator 500 can perform a comparison operation 505 to determine variations between object model 501 and build information 503. In this example, comparison operation 505 determines variations 507 and variations 509. Variations 507 are spaces that are missing portions of the build piece, i.e., spaces that do not include a portion of the build piece, even though the spaces should include portions of the build piece. Variations 509 are spaces that include extra build piece portions, i.e., spaces that include portions of the build piece, even though the spaces should not include portions of the build piece. Variations 507 and 509 can be sent to a compensator 511 to determine modifications to print instructions.

In various embodiments, variations can include size, shape (e.g., deformation), completeness of fusion, location, etc. In various embodiments, the characterizer can sense whether the fusing of the powder material in an area of the powder layer is complete after the energy beam is applied to the powder material in the area for a predetermined time, and the compensator can modify the print instructions to apply additional energy to the powder material in the area if the fusing of the powder material is incomplete after the predetermined time. For example, the modified print instructions can include an extra application of energy, e.g., the energy beam can return to the area of incomplete fusion after the slice has been scanned.

In various embodiments, the build information can include sensor information of a location of fused powder material in one of the layers that is sagging, for example. In this case, when the next layer of powder is deposited, the powder layer over the sagging area will be thicker than other areas of the powder layer. The compensator can increase the energy applied to the area of powder material deposited over the sagging area in the previous layer in order to ensure the thicker layer of powder will be completely fused. In this way, for example, a sagging area can be filled in with fused powder to build the height up to the desired level.

In various embodiments, the build information can include physics-based model information, which can predict areas of sagging before the sagging occurs, for example. In this case, the printing instructions can be modified to prevent or reduce the sagging. For example, the compensator can decrease the energy applied to the area of powder material that would sag if higher energy were applied. In this way, for example, compensation for sagging can be performed before the sagging occurs.

In various embodiments, the physics-based model can characterize a loss of fused powder material, for example, due to vaporization. In various embodiments, the physics-based model can characterize a melt pool viscosity of fused powder material.

In various embodiments, print instructions can be modified to compensate only for variations that are extra portions of the build piece, such as variations 509 above. For example, if a portion of the build piece bulges upward into a space that is not meant to include the build piece, the printing instructions can be modified to fuse less powder over the bulge when forming the next slice.

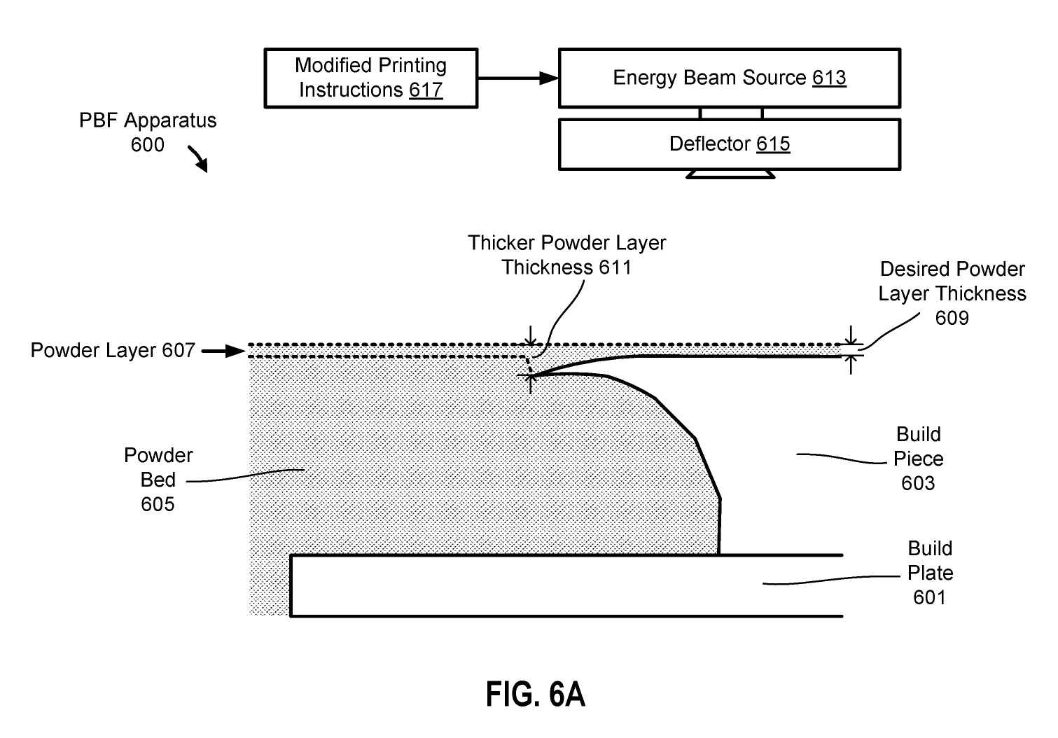

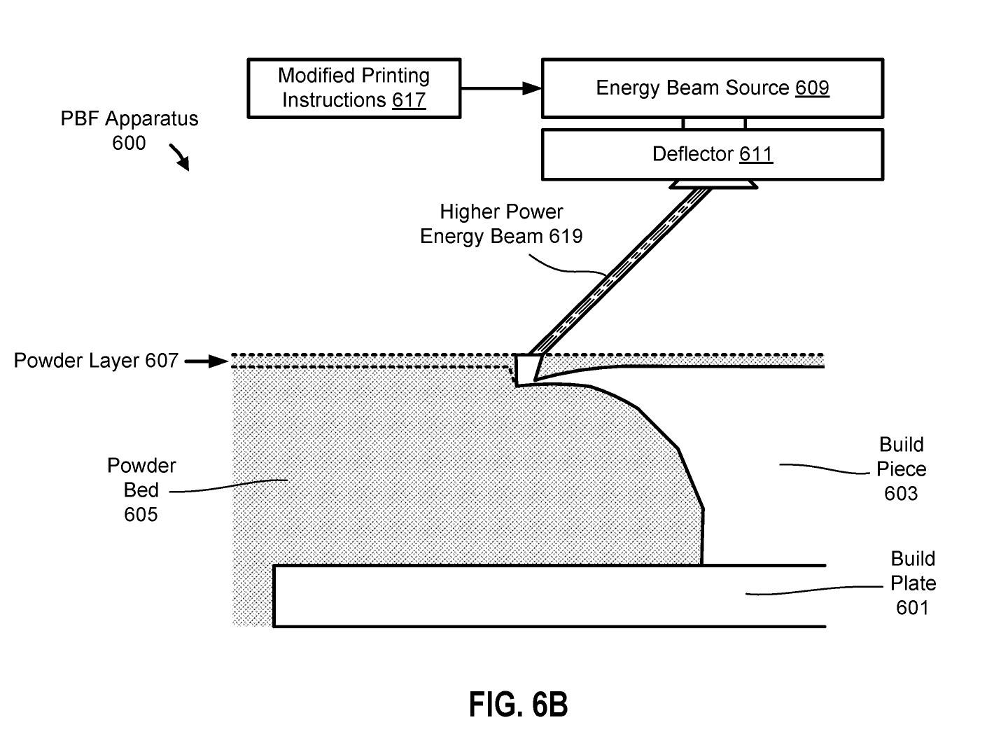

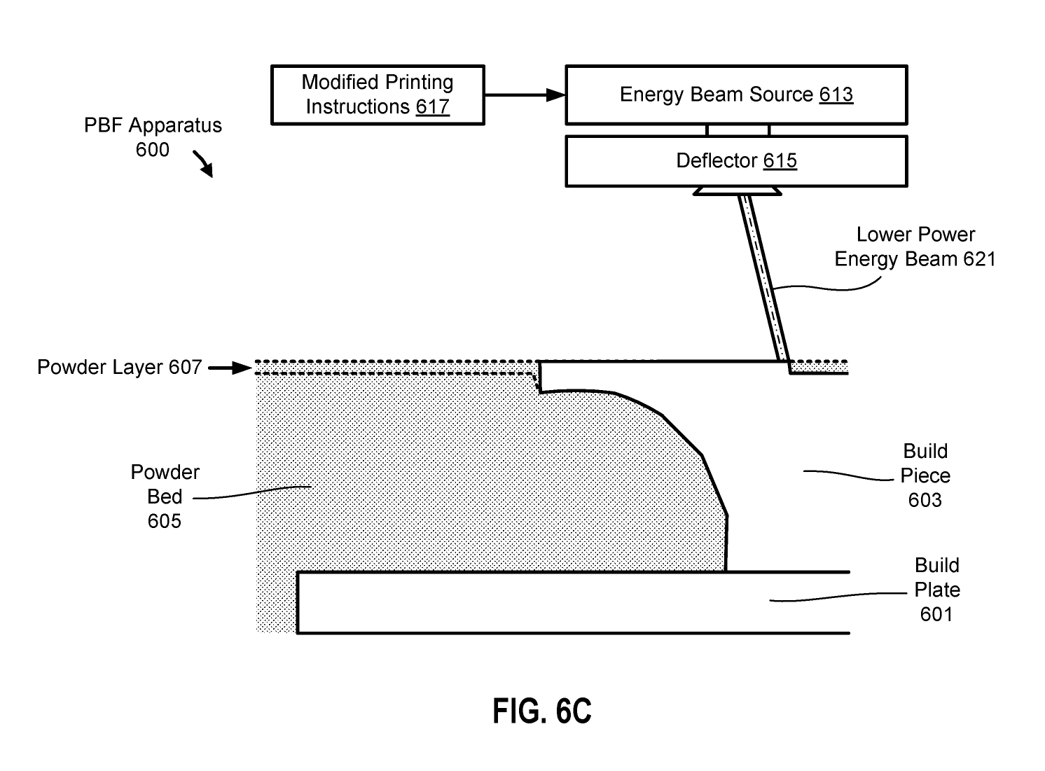

In various embodiments, print instructions can be modified to compensate only for variations that are missing portions of the build piece, such as variations 507 above. For example, if sagging occurs and real-time compensation is being used, it may not be possible to correct the portions of the build piece that have sagged into spaces that are not meant to include the build piece. In this case, the printing instructions can be modified to fuse more powder in the space over the sagging area when forming the next slice, such as illustrated in the example of FIG. 6 below. In this way, for example, the missing portion of the build piece may be corrected, but the sagging portion underneath remain. The sagging portion may be removed after the printing process by, for example, filing, sanding, etc.

FIGS. 6A-C illustrate an exemplary application of energy to a powder layer using modified printing instructions. As shown in FIG. 6A, a PBF apparatus 600 includes a build plate 601 on which a build piece 603 is formed in a powder bed 605. Powder bed 605 includes a powder layer 607 with a desired powder layer thickness 609. A portion of powder layer 607 has a thicker powder layer thickness 611 that over a sagging part of build piece 603 and, therefore, is thicker than desired powder layer thickness 609. PBF apparatus 600 also includes an energy beam source 613 and a deflector 615. Modified printing instructions 617 have been generated to compensate for the increased thickness of powder layer 607 over the sagging part of build piece 603. In this example, modified printing instructions 617 modify a beam power of energy beam source 613.

FIG. 6B illustrates the fusing of powder in a portion of powder layer 607 with thicker powder layer thickness 611 using a modified beam power. Specifically, in order to fuse the portion of powder layer 607 with thicker powder layer thickness 611, modified printing instructions 617 instructs energy beam source 613 to increase the beam power to effectuate a higher power energy beam 619 when scanning over the thicker portion of the powder layer. In this way, for example, more energy can be applied to the portion of powder layer 607 with thicker powder layer thickness 611 so that the powder can be completely fused.

FIG. 6C illustrates the fusing of powder in a portion of powder layer 607 with desired powder layer thickness 609. In this case, modified printing instructions 617 can instruct energy beam source 613 to lower the beam power to effectuate a lower power energy beam 621, which can be the beam power used to fuse powder with desired powder layer thickness 609 completely.

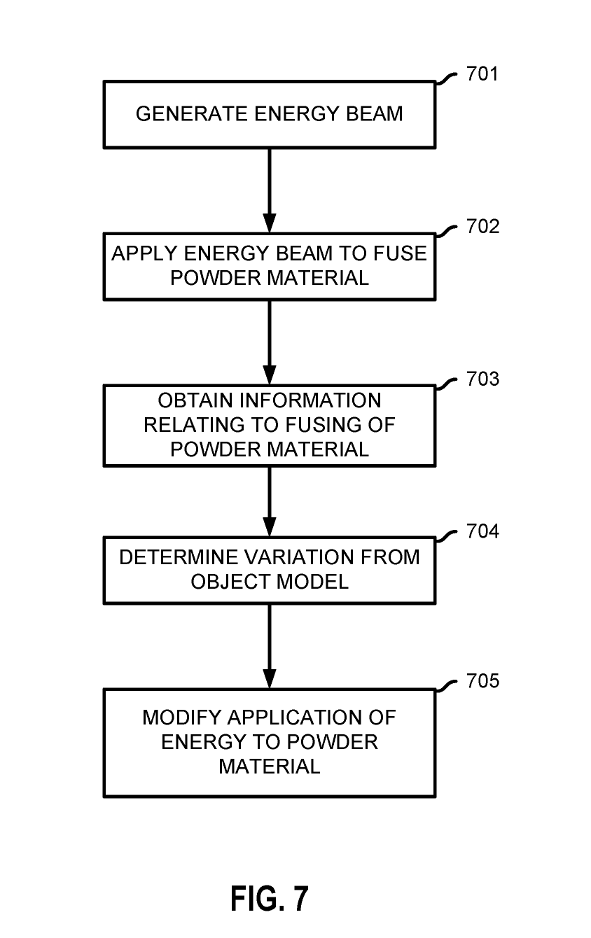

FIG. 7 is a flowchart illustrating an exemplary method of closed-loop compensation for PBF systems. A PBF system can generate (701) an energy beam and can apply (702) the energy beam to fuse powder material to create a three-dimensional (3-D) object that has an object model. The PBF system can obtain (703) information relating to the fusing of the powder material. For example, the information can include sensor information of the shape of the build piece (e.g., deformations, sagging, etc.), the completeness of fusing, etc. The PBF system can determine (704) a variation from the object model based on the information. For example, if the information indicates sagging in a particular area, the system can determine an amount of the sagging. The PBF system can modify (705) the application of energy to the powder material based on the information. For example, the system can increase the beam power of the energy beam to completely fuse areas of thicker powder, based on the information of the amount of sagging. In various embodiments, modifying the application of energy can include modifying printing instructions. In various embodiments, modifying the application of energy can include real-time modification of beam power, scanning rate, etc., based on feedback from one or more sensors. For example, a temperature sensor can sense a temperature at the beam location that is too low for melting powder, and the beam power can be increased based on the sensed temperature. In various embodiments, modifying the application of energy can be accomplished by modifying printing instructions for a next layer, e.g., when sagging in the previous layer is detected, beam power can be increased for fusing powder in the next layer that is over the sagging portion of the previous layer.

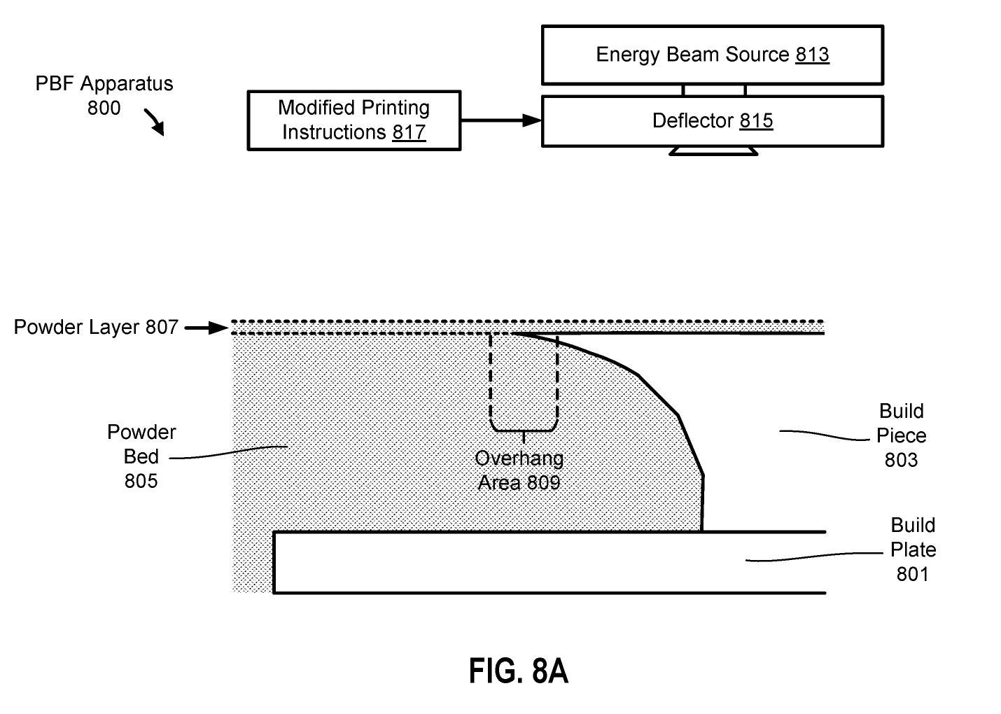

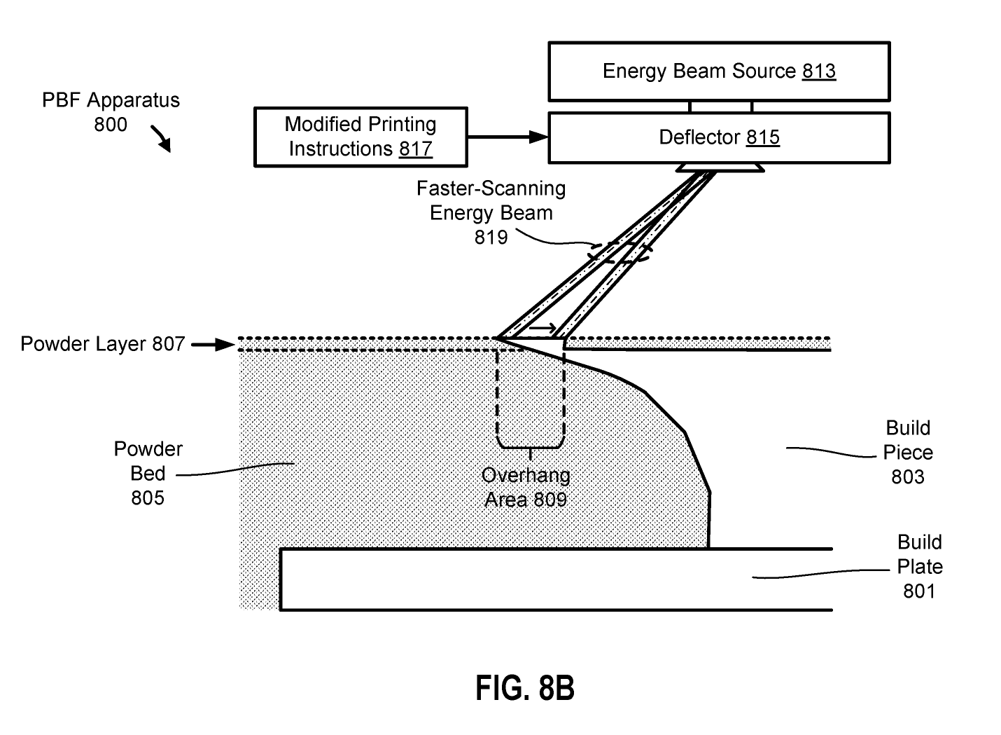

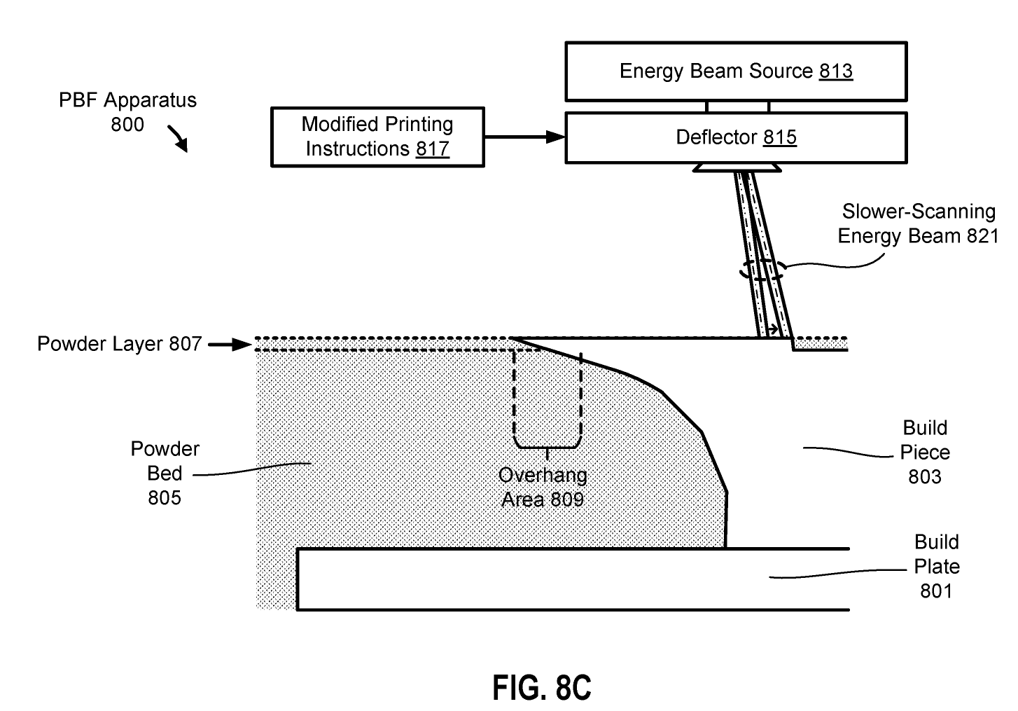

FIGS. 8A-C illustrate another exemplary application of energy to a powder layer using modified printing instructions. As shown in FIG. 8A, a PBF apparatus 800 includes a build plate 801 on which a build piece 803 is formed in a powder bed 805. Powder bed 805 includes a powder layer 807. A portion of powder layer 807 is in an overhang area 809. PBF apparatus 800 also includes an energy beam source 813 and a deflector 815.

In this example, a feed forward process (such as described above with reference to FIG. 4) has been performed to determine modified printing instructions 817 to compensate for sagging that would occur when fusing powder layer 807 in overhang area 809. In this example, modified printing instructions 817 modify a beam scanning rate of deflector 815.

FIG. 8B illustrates the fusing of powder in a portion of powder layer 807 in overhang area 809 using a modified beam scanning rate. Specifically, in order to fuse the portion of powder layer 807 in overhang area 809 without causing sagging, modified printing instructions 817 instructs deflector 815 to increase the beam scanning rate to effectuate a faster-scanning energy beam 819 when scanning in overhang area 809. In this way, for example, less energy can be applied to the portion of powder layer 807 in overhang area 809 so that the fused powder does not sag.

FIG. 8C illustrates the fusing of powder in a portion of powder layer 807 outside of overhang area 809. In this case, modified printing instructions 817 can instruct deflector 815 to decrease the beam scanning rate to effectuate a slower-scanning energy beam 821, which can be the beam scanning rate used to fuse powder that is not in an overhang area.

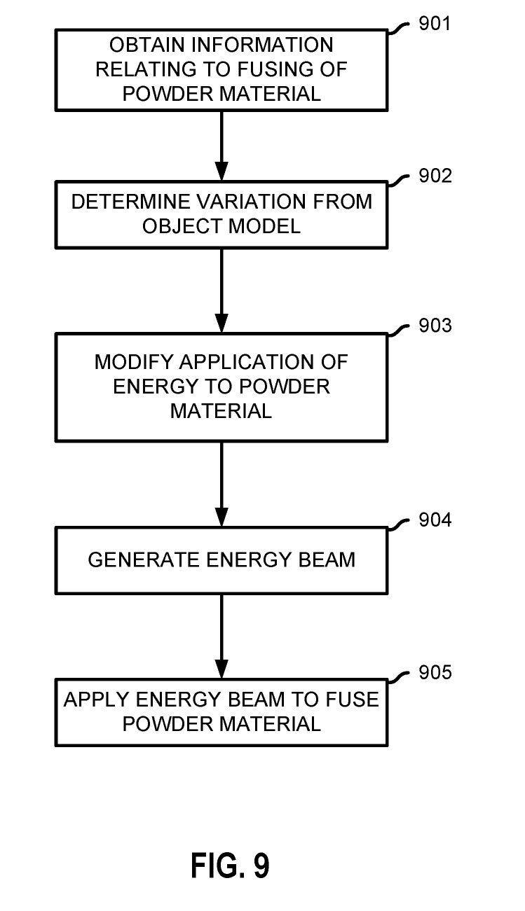

FIG. 9 is a flowchart illustrating an exemplary method of feed forward compensation for PBF systems. A PBF system can obtain (901) information relating to the fusing of the powder material. For example, the information can include a physics-based model predicting the shape of the build piece (e.g., deformations, sagging, etc.), the completeness of fusing, etc. The PBF system can determine (902) a variation from the object model based on the information. For example, if the information predicts sagging in a particular area, the system can determine an amount of the sagging. The PBF system can modify (903) the application of energy to the powder material based on the information. For example, the system can increase the scanning rate of the energy beam to prevent sagging, based on the information of the predicted amount of sagging. In various embodiments, modifying the application of energy can include modifying printing instructions. The PBF system can generate (904) an energy beam and can apply (905) the energy beam to fuse powder material to create a three-dimensional (3-D) object that has an object model.

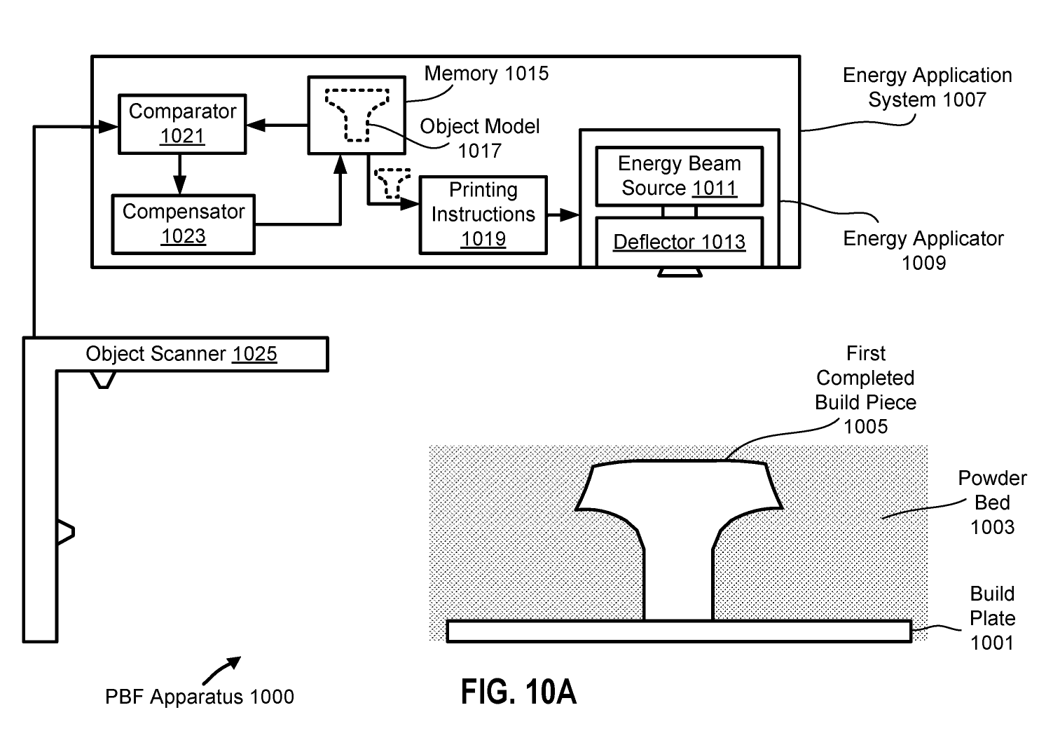

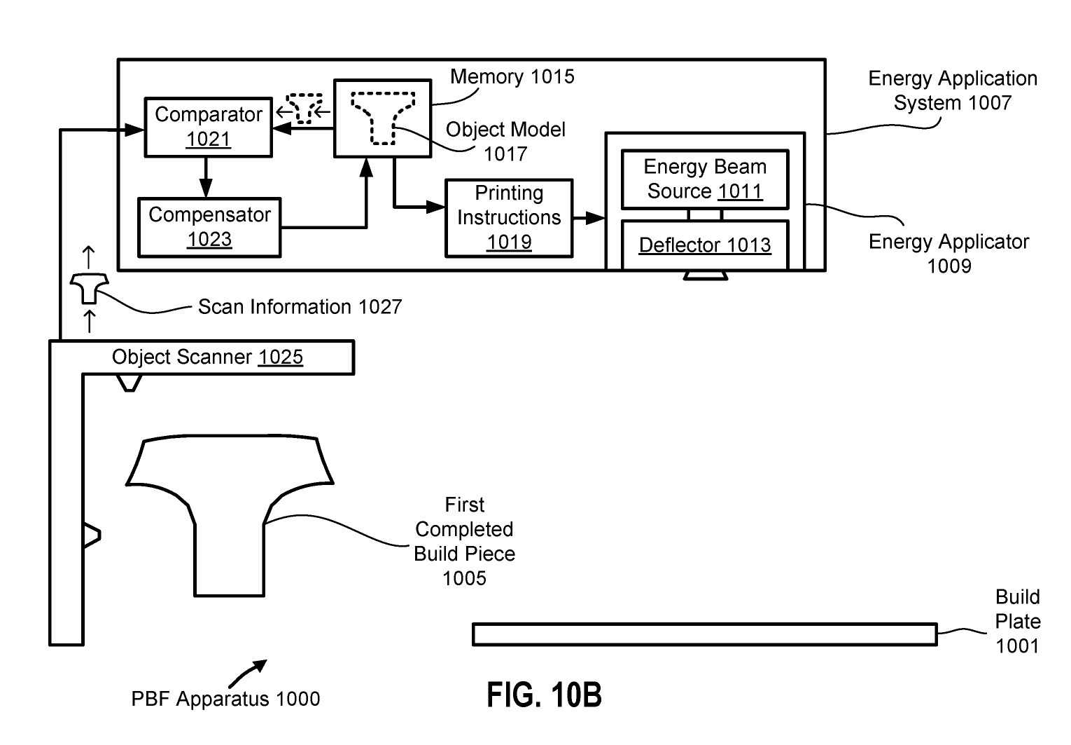

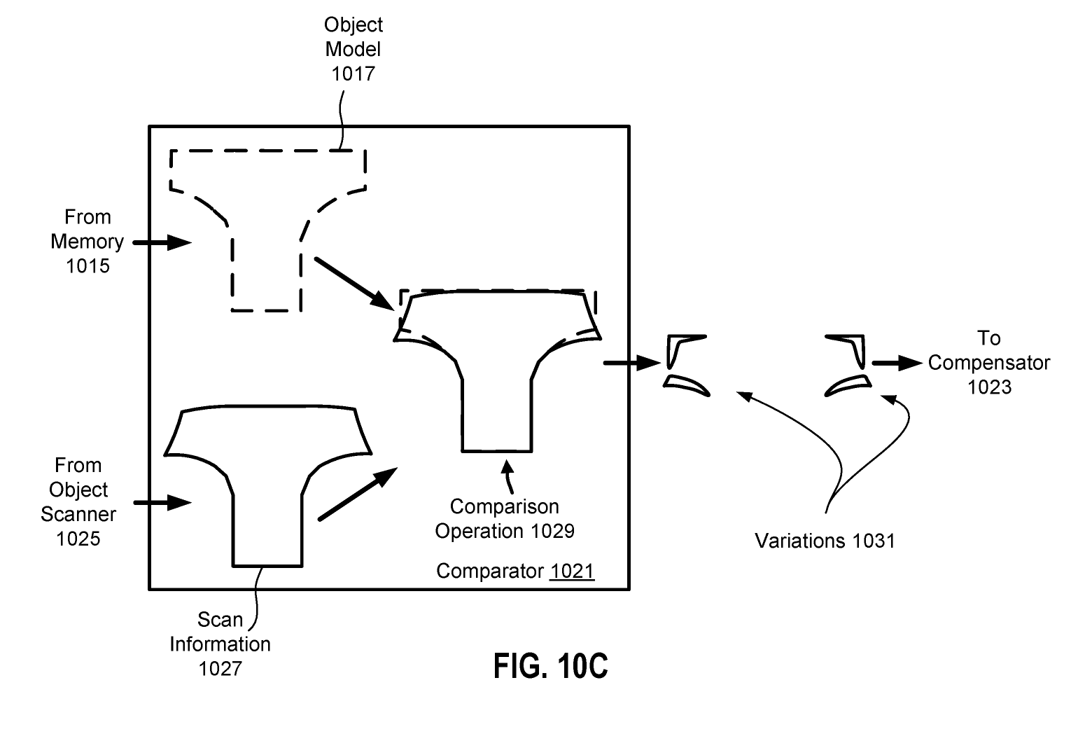

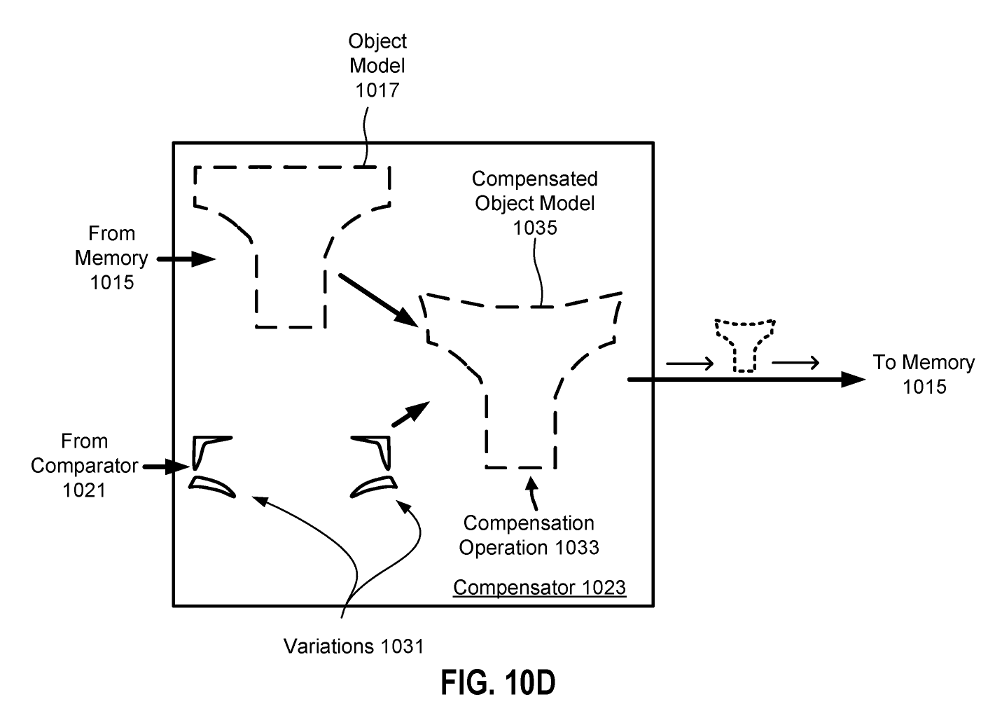

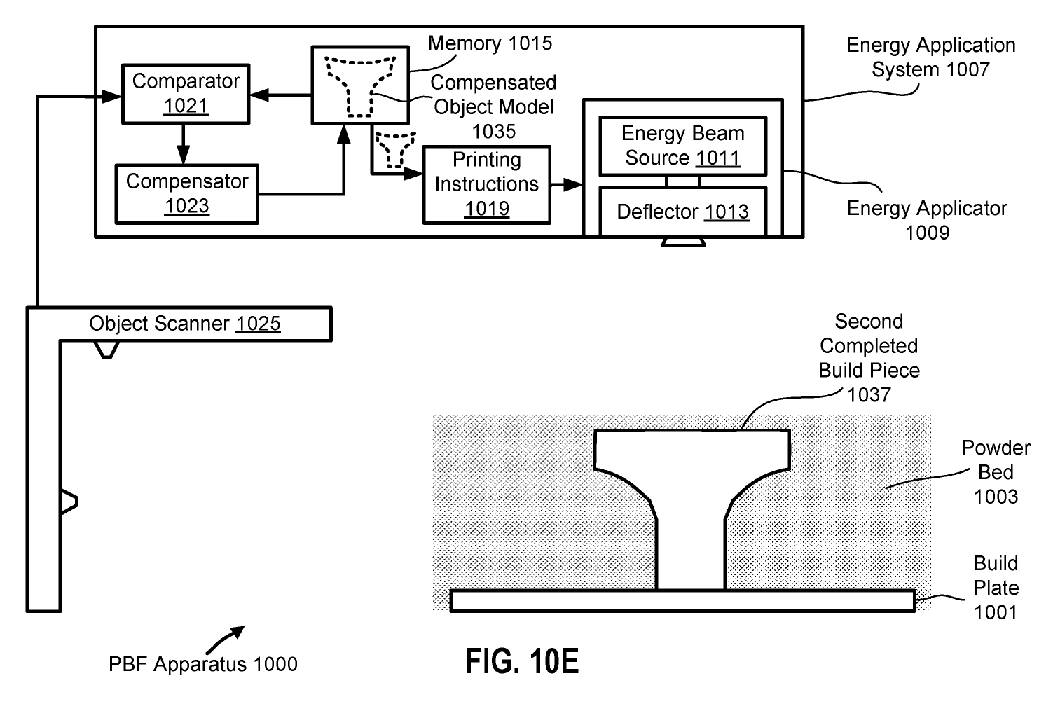

FIGS. 10A-E illustrate an exemplary PBF apparatus 1000 with post-processing closed-loop control. FIG. 10A illustrates PBF apparatus 1000 after a completed printing run. PBF apparatus 1000 includes a build plate 1001. A powder bed 1003 and a first completed build piece 1005 are on build plate 1001. PBF apparatus also includes an energy application system 1007 that includes an energy beam applicator 1009, with an energy beam source 1011 and a deflector 1013, a memory 1015 including an object model 1017, printing instructions 1019, a comparator 1021, and a compensator 1023. PBF apparatus 1000 also includes an object scanner 1025.

In this example, first completed build piece 1005 is the first build piece printed based on object model 1017. As shown in FIG. 10A, printing instructions 1019 obtains object model 1017 from memory 1015, and the printing instructions are based on the object model. However, first completed build piece 1005 has portions that are not the correct shape compared to object model 1017. Therefore, PBF apparatus 1000 performs a compensation procedure, as shown in FIGS. 10B-E.

FIG. 10B illustrates an object scanning procedure of PBF apparatus 1000. Specifically, first completed build piece 1005 is scanned by object scanner 1025 to obtain dimensional information of the shape of the first completed build piece. The dimensional information is sent as scan information 1027 to comparator 1021. In addition, comparator 1021 receives object model 1017 from memory 1015. Comparator 1021 performs a comparison operation, which is shown in FIG. 10C, to determine variations between object model 1017 and scan information 1027.

FIG. 10C illustrates an operation of comparator 1021. Comparator 1021 receives object model 1017 from memory 1015 and receives scan information 1027 from object scanner 1025. Comparator 1021 performs comparison operation 1029 to determine variations 1031 between object model 1017 and scan information 1027 and sends the variations to compensator 1023.

FIG. 10D illustrates an operation of compensator 1023. Compensator 1023 receives object model 1017 from memory 1015 and receives variations 1031 from comparator 1021. Compensator 1023 performs a compensation operation 1033 to determine a compensated object model 1035. Printing instructions generated from compensated object model 1035 will result in the printing of a build piece that matches object model 1017. In other words, compensated object model 1035 compensates for the errors that occurred when printing first completed build piece 1005. Compensator 1023 sends compensated object model 1035 to be stored in memory 1015.

FIG. 10E illustrates a second completed build piece 1037, resulting from printing using compensated object model 1035. When printing second completed build piece 1037, printing instructions 1019 is based on compensated object model 1035. In this way, for example, the shape of second completed build piece 1037 can match the shape of object model 1017. In fact, once compensated object model 1035 has been determined, every subsequent build piece can match the shape of object model 1017.

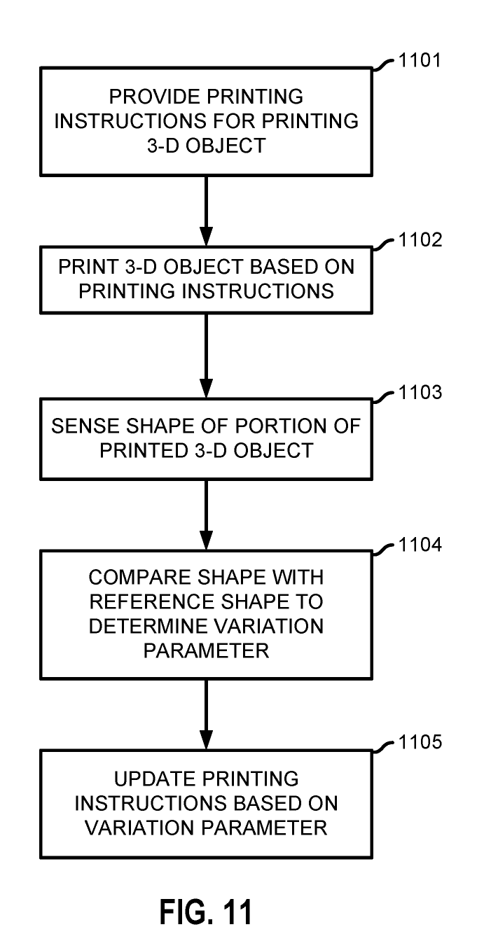

FIG. 11 is a flowchart illustrating another exemplary method of compensation for PBF systems. A PBF system can provide (1101) printing instructions for printing a 3-D object and can print (1102) the 3-D object based on the printing instructions. For example, the system can print a first build piece, such as first completed build piece 1005 in FIG. 10A. The PBF system can sense (1103) the shape of at least a portion of the printed 3-D object. For example, the first build piece can be scanned by an object scanner, such as object scanner 1025. The PBF system can compare (1104) the shape of the printed 3-D object with a reference shape, such as object model 1017, to determine a variation parameter, such as dimensional differences in shape. The PBF system can update (1105) the printing instructions based on the variation parameter. For example, printing instructions can be updated based on a compensated object model, such as compensated object model 1035, which can be determined by the variation parameter.

The previous description is provided to enable any person skilled in the art to practice the various aspects described herein. Various modifications to these exemplary embodiments presented throughout this disclosure will be readily apparent to those skilled in the art. Thus, the claims are not intended to be limited to the exemplary embodiments presented throughout the disclosure, but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. An apparatus for powder-bed fusion, comprising:
a powder-bed fusion system including an energy beam source that generates an energy beam and a deflector that applies the energy beam to fuse powder material to create a three-dimensional (3-D) object based on an object model;
a characterizer that obtains information relating to the fusing of the powder material;
a comparator that determines a variation from the object model based on the information; and
a compensator that modifies the application of energy to the powder material based on the variation.

2. The apparatus of claim 1, wherein the compensator is further configured to vary the applied energy by adjusting a power of the energy beam.

3. The apparatus of claim 1, wherein the compensator is further configured to vary the applied energy by adjusting a speed of the deflector.

4. The apparatus of claim 1, wherein the characterizer includes an edge sensor that senses information of an edge of fused powder material, and the information includes the information of the edge of the fused powder material.

5. The apparatus of claim 1, wherein the characterizer includes a thermal sensor that senses thermal information, and the information includes the thermal information.

6. The apparatus of claim 1, wherein the powder-bed fusion system includes a depositor that deposits the powder material in a plurality of layers and the deflector applies the energy beam to fuse the powder material in each of the layers.

7. The apparatus of claim 6, wherein the information comprises a location of fused powder material in a first one of the layers, and the compensator is further configured to vary the applied energy by increasing the energy applied to the powder material deposited immediately above the location in a second one of the layers.

8. The apparatus of claim 6, wherein the characterizer is configured to sense whether the fusing of the powder material in an area in one of the layers is complete after the energy beam is applied to the powder material in the area for a predetermined time, and the compensator is configured to vary the applied energy by applying additional energy to the powder material in the area if the fusing of the powder material is incomplete after the predetermined time.

9. The apparatus of claim 1, wherein the characterizer includes an optical sensor, and the information includes optical information obtained from the optical sensor.

10. The apparatus of claim 1, wherein the information comprises a physics-based model.

11. The apparatus of claim 10, wherein the physics-based model characterizes a sagging of fused powder material, and the compensator is configured to compensate for the sagging.

12. The apparatus of claim 11, wherein the powder-bed fusion system includes a depositor that deposits the powder material, and the sagging is caused by a force due to the depositing of the powder material.

13. The apparatus of claim 10, wherein the physics-based model characterizes a loss of fused powder material, and the compensator is configured to compensate for the loss of fused material.

14. The apparatus of claim 13, wherein the loss of fused powder material is caused by vaporization.

15. The apparatus of claim 10, wherein the physics-based model characterizes a melt pool viscosity of fused powder material, and the compensator is configured to compensate for the melt pool viscosity.

16. An apparatus for powder-bed fusion, comprising:
an adaptive controller that provides instructions for printing a three-dimensional (3-D) object, the instructions based on a data model of the 3-D object;
a powder-bed fusion system that prints the 3-D object based on the instructions; and
a feedback system configured to sense a shape of at least a portion of the printed 3-D object, compare the sensed shape with a reference shape to determine a variation parameter, and update the instructions based on the variation parameter.

17. A method of powder-bed fusion, comprising:
generating an energy beam;
applying the energy beam to fuse powder material to create a three-dimensional (3-D) object based on an object model;
obtaining information relating to the fusing of the powder material;
determining a variation from the object model based on the information; and
modifying the application of energy to the powder material based on the information.

18. The method of claim 17, wherein varying the energy applied to the powder material includes adjusting a power of the energy beam.

19. The method of claim 17, wherein varying the energy applied to the powder material includes adjusting a speed at which the energy beam is applied.

20. The method of claim 17, wherein the information includes information of an edge of fused powder.

21. The method of claim 17, wherein the information includes thermal information.

22. The method of claim 17, further comprising depositing the powder material in a plurality of layers, and wherein the energy beam is applied to fuse the powder material in each of the layers.

23. The method of claim 22, wherein the information comprises a location of fused powder material in a first one of the layers, and varying the applied energy includes increasing the energy applied to the powder material deposited immediately above the location in a second one of the layers.

24. The method of claim 22, further comprising sensing whether the fusing of the powder material in an area in one of the layers is complete after the energy beam is applied to the powder material in the area for a predetermined time, and the compensator is configured to vary energy applied to the powder material by applying additional energy to the powder material in the area.

25. The method of claim 24, wherein the information includes optical information.

26. The method of claim 17, wherein the information includes a physic-based model.

27. The method of claim 26, wherein the physics-based model characterizes a sagging of fused powder material, and varying the applied energy includes varying the applied energy to compensate for the sagging.

28. The method of claim 27, further comprising depositing the powder material, wherein the sagging is caused by a force due to depositing the powder material.

29. The method of claim 26, wherein the physics-based model characterizes a loss of fused powder material, and varying the applied energy includes varying the applied energy to compensate for the loss of fused material.

30. The method of claim 29, wherein the loss of fused powder material is caused by vaporization.

31. The method of claim 26, wherein the physics-based model characterizes a melt pool viscosity of fused powder material, and varying the applied energy includes varying the applied energy to compensate for the melt pool viscosity.

32. A method of powder-bed fusion, comprising:
providing instructions for printing a three-dimensional (3-D) object, the instructions based on a data model of the 3-D object; and
printing the 3-D object based on the instructions;
sensing a shape of at least a portion of the printed 3-D object;
comparing the sensed shape with a reference shape to determine a variation parameter; and
updating the instructions based on the variation parameter.
